(19) United States
(12) Patent Application Publication
(10) Pub. No.: US 2019/0190811 A1
(43) Pub. Date: Jun. 20, 2019

(54) AUTOMATIC SHARING OF ROUTING INFORMATION BETWEEN NEIGHBORING ROUTERS USING A LINK-LOCAL ADDRESS

(71) Applicant: Lenovo Enterprise Solutions (Singapore) Pte. Ltd., Singapore (SG)

(72) Inventors: Venkatesan Selvaraj, Sunnyvale, CA (US); Dan Rosu, Bucuresti (RO); Lucian Stoian, Bucuresti (RO)

(21) Appl. No.: 15/842,221

(22) Filed: Dec. 14, 2017

(51) Int. Cl. H04L 12/751; H04L 12/933; H04L 29/12; H04L 29/08

(52) U.S. Cl. CPC H04L 45/02; H04L 49/1515; H04L 61/6022; H04L 61/1541; H04L 67/141; H04L 61/103

(57) ABSTRACT

A router, computer program product and method for a first router to automatically share network routing information with a second router over a direct link between the first router and the second router. The first router receives a link layer message over the direct link with the second router, where the message includes a media access control address. The first router obtains an IPv6 link-local address and an autonomous system identifier (AS) for the linked port of the second router and stores the address and the AS in memory in association with the second router as a gateway protocol neighbor directly connected by the link. In response to receiving the link layer message, the first router establishes a gateway protocol session over the link using the address. During the session, the first router transmits routing information to the second router using the address.

### BACKGROUND

The present disclosure relates to the configuration of links between routers in a network.

### BACKGROUND OF THE RELATED ART

A Clos network is a kind of multistage network that includes multistage switching systems. Some modern data centers may implement a Clos-based network, as well as other network topologies, using Border Gateway Protocol (BGP). Regardless of the exact network topology, it is necessary to manually configure the Internet Protocol (IP) addresses for each link between routers and manually enable BGP on the links between the routers. Coming up with the Internet Protocol (IP) addresses to use on each of the links presents a high level of complexity and the manual configurations can be prone to error.

In order to configure such network topology, a user would typically create a separate subnet on each link between routers. Then, the challenge would be to identify many unique subnets (one for each link) and many unique IPv4 addresses (one for each of the two interfaces to each link). For a system with a large number of routers, the manual selection and assignment of so many IPv4 addresses is time consuming and challenging to avoid mistakes.

### BRIEF SUMMARY

One embodiment provides a computer program product comprising non-transitory computer readable storage media having program instructions embodied therewith for a first router to automatically share network routing information with a second router over a direct link between the first router and the second router. The program instructions are executable by a processor to: receive a link layer message at the first router over the direct link with the second router, wherein neither of the first and second routers has been assigned an IPv4 address, and wherein the link layer message includes a media access control address for the second router; obtain an IPv6 link-local address and an autonomous system identifier for the second router; store, in memory of the first router, the IPv6 link-local address and the autonomous system identifier in association with the second router as a gateway protocol neighbor directly connected by the link; establish, in response to receiving the link layer message, a gateway protocol session between the first router and the second router using the IPv6 link-local address for the second router; and transmit, during the gateway protocol session, routing information from a routing information base of the first router to the second router using the IPv6 link-local next hop address of second router.

Another embodiment provides a router comprising at least one non-transitory data storage device for storing program instructions and at least one processor for processing the program instructions to: receive a link layer message at the first router over the direct link from a second router, wherein neither of the first and second routers has been assigned an IPv4 address, and wherein the link layer message includes a media access control address for the second router; obtain an IPv6 link-local address and an autonomous system identifier for the second router; store, in memory of the first router, the IPv6 link-local address and the autonomous system identifier in association with the second router as a gateway protocol neighbor directly connected by the link; establish, in response to receiving the link layer message, a gateway protocol session between the first router and the second router using the IPv6 link-local address for the second router; and transmit, during the gateway protocol session, routing information from a routing information base of the first router to the second router using the IPv6 link-local next hop address of second router.

Yet another embodiment provides a method for a first router to automatically share network routing information with a second router over a direct link between the first router and the second router. The method comprises: receiving a link layer message at the first router over the direct link from the second router, wherein neither of the first and second routers has been assigned an IPv4 address, and wherein the link layer message includes a media access control address for the second router; obtaining an IPv6 link-local address and an autonomous system identifier for the second router; storing, in memory of the first router, the IPv6 link-local address and the autonomous system identifier in association with the second router as a gateway protocol neighbor directly connected by the link; establishing, in response to receiving the link layer message, a gateway protocol session between the first router and the second router using the IPv6 link-local address for the second router; and transmitting, during the gateway protocol session, routing information from a routing information base of the first router to the second router using the IPv6 link-local address of second router as the next hop address.

### BRIEF DESCRIPTION OF THE SEVERAL VIEWS OF THE DRAWINGS

FIG. 1 is a diagram of a network including a plurality of line cards, fabric cards and servers connected the line cards.

FIG. 2 is a diagram of a router that is representative of any of the routers (i.e., line cards and/or fabric cards) in the network of FIG. 1.

FIGS. 3A and 3B are diagrams of logic modules and data structures used by the router in FIG. 2 in implement various embodiments.

FIG. 4A is a diagram of an Ethernet frame forming an LLDP Advertisement including an LLDP Data Unit that provides for optional Type-Length-Value (TLV) fields.

FIG. 4B is a diagram of BGP Configuration TLV fields that may be used to convey BGP configuration information in the optional TLV fields of the LLDP Advertisement of FIG. 4A.

FIG. 5 is a diagram of a Routing Information Base of FIG. 3, including a Global BGP Configuration table and a Specific BGP Neighbor Configuration table.

FIG. 6 is a flow diagram of a method for a first router to automatically share network routing information with a second router over a direct link between the first router and the second router.

### DETAILED DESCRIPTION

One embodiment provides a computer program product comprising non-transitory computer readable storage media having program instructions embodied therewith for a first router to automatically share network routing information with a second router over a direct link between the first router and the second router. The program instructions are executable by a processor to: receive a link layer message at the first router over the direct link the second router, wherein neither of the first and second routers has been assigned an IPv4 address, and wherein the link layer message includes a media access control address for the second router; obtain an IPv6 link-local address and an autonomous system identifier for the second router; store, in memory of the first router, the IPv6 link-local address and the autonomous system identifier in association with the second router as a gateway protocol neighbor directly connected by the link; establish, in response to receiving the link layer message, a gateway protocol session between the first router and the second router using the IPv6 link-local address for the second router; and transmit, during the gateway protocol session, routing information from a routing information base of the first router to the second router using the IPv6 link-local next hop address of second router.

The first and second routers may be in the same network topology or on the borders of two adjacent network topologies. Furthermore, the network or networks may have any topology without limitation. Wherein the first and second routers are in the same network, the first router may be selected from the group consisting of a line card and a fabric card. Optionally, the first router is a line card and the second router is a fabric card, or the first router is a fabric card and the second router is a line card. Furthermore, the network may be a multistage network including a plurality of line cards, a plurality of fabric cards, and a plurality of servers, wherein each server has a direct link to a line card, each line card has a direct link to each fabric card, there is no direct link between any two of the line cards, and there is no direct link between any two of the fabric cards. In one specific implementation, the first and second routers may be in a multistage network having a topology referred to as a Clos network.

In one option, the link layer message may be a Link Layer Discovery Protocol (LLDP) message. An instance of LLDP or logic implementing a similar protocol may be run on each of the first and second routers, and preferably on each of a plurality of routers within the network. Accordingly, each router may advertise various information in a link layer message to other routers to which the router is connected by a link. In this manner, each router may obtain a media access control address for the router on the opposing end of a routed link.

The gateway protocol, namely Border Gateway Protocol (BGP), is responsible for exchanging routing and reachability information among autonomous systems (AS) over the network or between networks. An instance of BGP or logic implementing a similar gateway protocol may be run on each of the first and second routers, and preferably on each of a plurality of routers within the network. Accordingly, a BGP session may be established between BGP neighbors, also referred to as peers, to facilitate exchange of routing information.

Each BGP route may have a number of attributes, including an attribute that is the path of AS numbers in the route from a source to a destination. A route may be considered as an Equal Cost Multipath (ECMP) route if there is more than one route having the same path. For example, if a first route of “dest1 with nexthop1” has an AS path (AS1, AS2, AS3) and a second route of “dest1 with nexthop2” has an AS path (AS1, AS2, AS3), then the two routes are ECMP because they have the same path. If the second route had an AS path (AS4, AS5, AS6), then the two routes would not normally be considered ECMP even though both routes have the same number of AS identifiers in their paths. However, “Multipath Relax” is a capability that allows non-identical paths to be considered to be ECMP. Multipath Relax may be either enabled or disabled.

The term “BGP peering” refers to the process of exchanging and updating router information between two routers. The disclosed embodiments may include the exchange of IPv4 routes between two routers which send their IPv4 route information to a BGP neighbor at their IPv6 link-local address, wherein the BGP neighbor implements an IPv4 address family, and wherein the IPv4 routes include IPv6 link-local nexhops. BGP will support Multi Protocol (MP) Extension of Address Family Identifiers/Subsequent Address Family Identifiers (AFI/SAFI) Definitions for the IPv4 Address Family to include IPv6 Next Hop address in the Network Layer Reachability Information (NLRI). This capability is supported by default and will be negotiated when receiving open messages from the BGP neighbors.

This means that the BGP neighbors or peers establish a connection using their respective IPv6 link-local addresses, but provide IPv4 routing information in the BGP packets transferred over the connection. Furthermore, the routing information uses an IPv6-link-local address as the next-hop for a route. Note that both of the BGP neighbors may implement dual-mode (dual-stack) TCP/IP support for both IPv4 and IPv6 (i.e., Multiprotocol Extensions for BGP) so that both neighbors will recognize the IPv6 link-local address as well as the IPv4 routing information.

For example, each route will identify a destination and a “through next-hop” to reach that destination. In a typical IPv4 case, a route to a network 1.1.1.0 through a next hop (router) with an IP address 2.2.2.2 might look like this:

| Route Destination | through Next-Hop |
|---|---|
| 1.1.1.0/24 | 2.2.2.2 |

According to an embodiment disclosed herein, the same route may be described with a mixed route (using both IPv4 and IPv6) to an IPv4 destination address through a next hop (router) having an IPv6 link-local address as follows:

| Route Destination | through Next-Hop |
|---|---|
| 1.1.1.0/24 | fe80::1:1:1:1 |

Note that fe80::/10 (1111 1110 10) is the prefix used to designate that an address is a link-local address.

Furthermore, the program instructions may be further executable by the processor to store, in the memory of the router, global gateway protocol information for the router, wherein the global gateway protocol information includes an autonomous system number, router identifier, address family, an equal cost multipath setting, and a multipath relax setting. The program instructions may be further executable by the processor to store, in the memory of the router, specific gateway protocol information for each other router to which the router is linked, wherein the specific gateway protocol information for each other router may include an autonomous system number, an address family of the second router and the IPv6 link-local address.

One embodiment of the program instructions executable by the processor to obtain the IPv6 link-local address for the second router may include program instructions executable by the processor to calculate the IPv6 link-local address and the autonomous system identifier using the media access control address received from the second router. The program instructions are preferably further executable by the processor to store, in the memory of the first router, the autonomous system number in association with the IPv6 link-local address for the second router.

A link-local address is an address that is unique to each individual port of a router (i.e., none of the ports have the same link-local address) and can be computed from the physical media address control (MAC) address of the router port. For example, a Line Card that has four ports that each form a link to four Fabric Cards will have a different IPv6 link-local address for each port of the Line Card. Furthermore, each link connected between a Fabric Card and a Line Card may be described by an IPv6 link-local address for the port on the Fabric Card side of the link and another IPv6 link-local address for the port on the Line Card side of the link.

Each routed port of each router (i.e., each of the Fabric Cards and Line Cards) has a default IPv6 autoconfigured link-local address, in EUI-64 (extended unique identifier) format, that may be derived from the MAC address of the port. The IPv6 link-local address is ensured to be unique because it is derived from the unique MAC address of the router port. For example, a link-local address is an IPv6 unicast address that can be automatically configured on any interface using the link-local prefix fe80::/10 (1111 1110 10) and the interface identifier (MAC address) in the modified EUI-64 format. In other words, a default link-local address is bound to the MAC address, but configured in an EUI-64 format. Each MAC address is by definition unique, so deriving the IPv6 link-local address from the MAC address ensures that adjacent routers will not have same IPv6 link-local address. Each IPv6 link-local address refers only to a particular physical link and is used for addressing on a single link to facilitate automatic address configuration. Accordingly, an IPv6 link-local address can be used by one router to reach a specific neighboring router attached to the link.

In one non-limiting example, if a router has a MAC address of 54:2a:a2:d3:ba:01, then the IPv6 link-local address may be determined to be fe80::562a:a2ff:fed3:ba01. In the foregoing IPv6 link-local address, “fe80::” is the link-local prefix, “ff:fe” represents the middle 16 bits used when converting from a MAC address to an IPv6 link-local address, and the underlined portions of the address are derived from the MAC address.

In one specific example, an IPv6 link-local address may be calculated from a MAC address as follows:

Step #1: Split the MAC address (0015.2BE4.9B60) in the middle:
0015.2B E4.9B60

Step #2: Insert FF:FE in the middle:
0015.2BFF.FEE4.9B60

Step #3: Change the format to use a colon delimiter:
0015:2BFF:FEE4:9B60

Step #4: Convert the first eight bits to binary:
00->00000000

Step #5: Flip the 7th bit:
00000000->00000010

Step #6: Convert these first eight bits back into hex:
00000010->02

Step #7: For the IPv6 link-local address in EUI-64 format:
0215:2BFF:FEE4:9B60

Each router will have a single MAC address. However, in various embodiments, a different IPv6 link-local address may be calculated for each port of a single router by considering an interface name and/or slot numbers. In one option, the IPv6 link-local address is calculated from the MAC address by using the EUI64 format and adding the interface name and/or slot numbers. For example, after the MAC address has been converted to EUI64 format (as shown above), the interface name and slot numbers may be added to the last (least significant) 2 or 3 bytes. In the following two specific examples, the interface name (port name) is a 2 tuple and 3 tuple interface name like Ethernet1/1 or Ethernet1/1/1.

### Specific Example 1

If the interface name includes a 2 tuple, such as “Ethernet1/1” (i.e., router 1, port 1), then the 2 tuple “1/1” may be used to uniquely modify the MAC address in EUI64 format. In this example, the router number “1” may be added to the 15^{th} byte of the MAC+EUI64 address, and the port number “1” may be added to the 16^{th} byte of the MAC+EUI64 address. If the MAC address is 542a.a2d3.ba01, then the MAC+EUI64 address would become fe80::562a:a2ff:fed3:ba01 using the 7 step process set out above. Then, by adding “1” to the 15^{th} byte and adding “1 to the 16^{th} byte, the IPv6 link-local address would become fe80::562a:a2ff:fed3:bb02 (note the underlining to emphasize the changes to the 15^{th} and 16^{th} bytes).

### Specific Example 2

If the interface name includes a 3 tuple, such as “Ethernet1/1/1” (i.e., router 1, slot 1, port 1), then the 3 tuple “1/1/1” may be used to uniquely modify the MAC address in EUI64 format. In this example, the router number “1” may be added to the 14^{th} byte of the MAC+EUI64 address, the slot number “1” may be added to the 15^{th} byte of the MAC+EUI64 address, and the port number “1” may be added to the 16^{th} byte of the MAC+EUI64 address. If the MAC address is 542a.a2d3.ba01, then the MAC+EUI64 address would become fe80::562a:a2ff:fed3:ba01 using the 7 step process set out above. Then, by adding “1” to the 14^{th} byte, “1” to the 15^{th} byte and adding “1 to the 16^{th} byte, the IPv6 link-local address would become fe80::562a:a2ff:fed4:bb02 (note the underlining to emphasize the changes to the 14^{th}, 15^{th} and 16^{th} bytes).

Based upon these examples, it should be recognized that there are many ways to modify a MAC+EUI64 address to using the interface name or identifier to ensure that an IPv6 link-local address is unique among the ports of a router even if the router has a single MAC address. For example, the values of the tuple could be added to other bytes or bit positions, or the calculation could involve subtraction or other mathematical operations. The embodiments disclosed herein should not be interpreted as being limited to the specific examples. Alternatively, a manufacturer may provide a separate MAC address on each link/port so that the MAC+EUI64 address will be unique without consideration of the interface name.

The AS number for a particular router may also be calculated from the MAC address on that router. In one example, the AS number is determined from the last 4 bytes of the 6 byte MAC address, such that there is a single AS number for the router.

Another embodiment of the program instructions executable by the processor to obtain the IPv6 link-local address and the autonomous system number for the second router include program instructions executable by the processor to read the IPv6 link-local address and the autonomous system number for the second router in the link layer message received at the first router over the link from the second router, and wherein the link layer message includes a type-length-value (TLV) packet including the IPv6 link-local address and the autonomous system number of the second router. The program instructions are preferably further executable by the processor to store, in the memory of the first router, the autonomous system number in association with the IPv6 link-local address for the second router.

Embodiments may use the obtained IPv6 link-local address and the autonomous system number for the second router to establish a BGP session with the second router and exchange routing information with the second router. The routing information may, for example, include a plurality of route records, where each route record identifies a destination address and a next hop address, and where one or more route record has an IPv4 address for the destination address and an IPv6 link-local address for the next hop address. Furthermore, the program instructions may be further executable by the processor to route IPv4 packets from the first router to the second router using the IPv6 link-local next hop address.

In a further option, a BGP instance running on a router may have a setting that allows a user to enable or disable auto-configuration of BGP neighborship. If a router has auto-configuration of BGP neighborship disabled, then the router will not establish a BGP connection. Furthermore, if auto-configuration of BGP neighborship is disabled, then the BGP instance may instruct the LLDP instance not to advertise BGP information.

Another embodiment provides a router comprising at least one non-transitory data storage device for storing program instructions and at least one processor for processing the program instructions to: receive a link layer message at the first router over the direct link from a second router, wherein neither of the first and second routers has been assigned an IPv4 address, and wherein the link layer message includes a media access control address for the second router; obtain an IPv6 link-local address and an autonomous system identifier for the second router; store, in memory of the first router, the IPv6 link-local address and the autonomous system identifier in association with the second router as a gateway protocol neighbor directly connected by the link; establish, in response to receiving the link layer message, a gateway protocol session between the first router and the second router using the IPv6 link-local address for the second router; and transmit, during the gateway protocol session, routing information from a routing information base of the first router to the second router using the IPv6 link-local next hop address of second router.

Yet another embodiment provides a method for a first router to automatically share network routing information with a second router over a direct link between the first router and the second router. The method comprises: receiving a link layer message at the first router over the direct link from the second router, wherein neither of the first and second routers has been assigned an IPv4 address, and wherein the link layer message includes a media access control address for the second router; obtaining an IPv6 link-local address and an autonomous system identifier for the second router; storing, in memory of the first router, the IPv6 link-local address and the autonomous system identifier in association with the second router as a gateway protocol neighbor directly connected by the link; establishing, in response to receiving the link layer message, a gateway protocol session between the first router and the second router using the IPv6 link-local address for the second router; and transmitting, during the gateway protocol session, routing information from a routing information base of the first router to the second router using the IPv6 link-local address of second router as the next hop address.

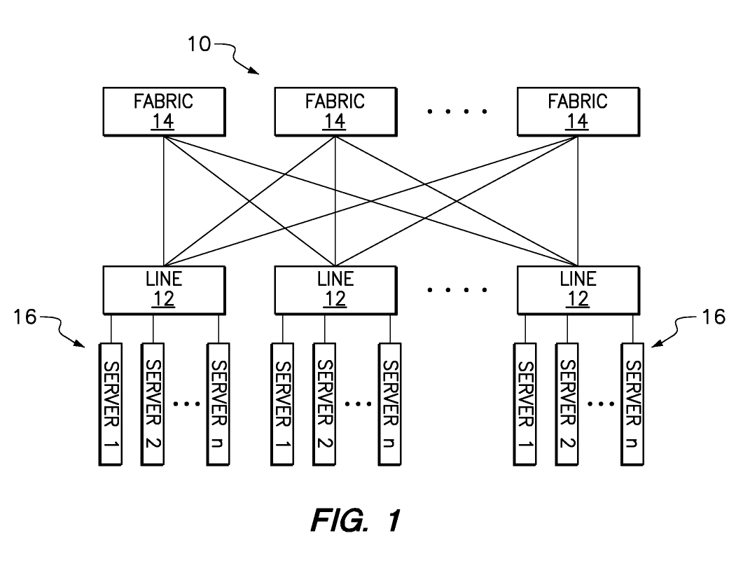

FIG. 1 is a diagram of a network 10 including a plurality of line cards (routers) 12, fabric cards (routers) 14 and servers 16 connected to the line cards 12. The routers in the network 10 are referred to as either “Line cards” 12 or “Fabric cards” 14 in reference to their function or position in the network tolopoly. The network 10 is illustrated as a Clos network design, which is a multistage network wherein each line card 12 (in a lower stage or layer) is directly connected with each fabric card 14 (in a top stage or layer). In a Clos network like the network 10, there is no direct connection (or link) between any two of the line cards, and there is no direct connection (or link) between any two of the fabric cards. There are only connections (links) between the lines cards 12 and the fabric cards 14. Each link (illustrated as a solid line between entities) is a connection between a port of a line card 12 (a router in a first stage) and a port of a fabric card 14 (a router in the second stage). Each link is a routed link, and every link needs both an IP address configuration and a configuration of BGP neighborship between the IP addresses. It should be recognized that embodiments described herein at not limited to a Clos network, but are equally applicable to various network topologies where there is a direct link between two routers.

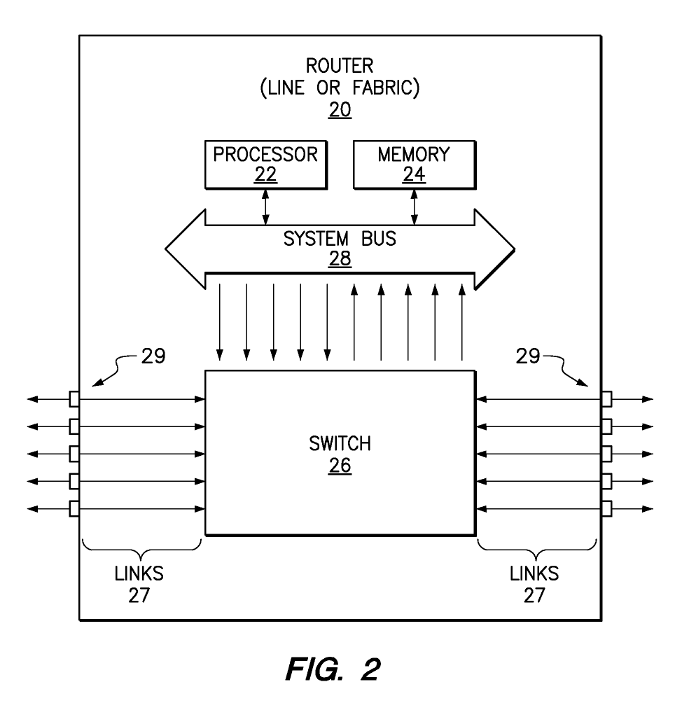

FIG. 2 is a diagram of a router 20 that is representative of any of the routers (i.e., line cards 12 and/or fabric cards 14) in the network 10 of FIG. 1. The router 20 includes a processor 22, memory 24, and a switch 26 each coupled to a system bus 28 for communication there between. Links 27 couple the switch 26 to input output ports 29 that enable a wired or wireless link with another router.

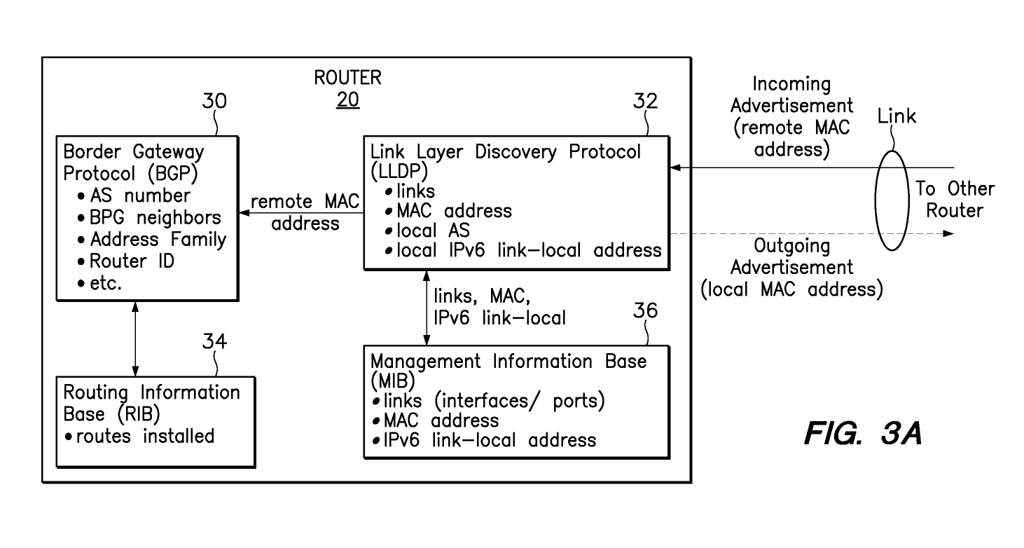

FIGS. 3A and 3B are diagrams of logic modules and data structures used by a router 20 in the disclosed embodiments. In both illustrations, the router 20 runs a single instance of the Border Gateway Protocol (BGP) module or process 30 and a single instance of the Link Layer Discovery Protocol (LLDP) module or process 32, and maintains a Routing Information Base (RIB) 34 and a Management Information Base (MIB) 36. It should be recognized that the router 20 may run additional processes and maintain additional data structures, without limitation. However, the disclosed embodiments may be implemented using the processes and data structures shown. For example, the Management Information Base (MIB) may store all local information about link/ports, MAC addresses, IPv4 and IPv6 interfaces. The LLDP process may locally store information from various modules registered to it to advertise, such as information from MIB, BGP or other module that wants to advertise information through LLDP advertisements. Still further, the BGP process may store local BGP information, such as the local AS number, the router ID, and BGP peer configurations.

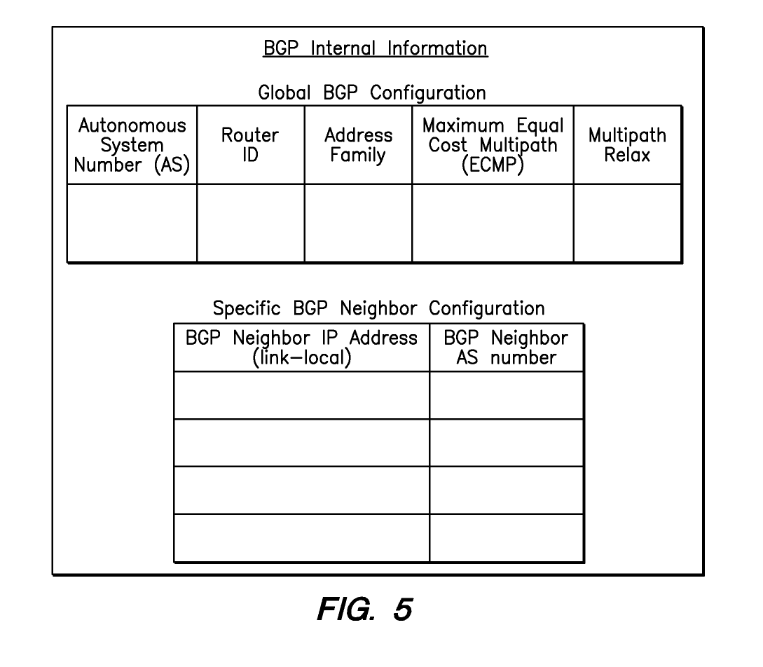

FIG. 3A is a diagram of the router 20 running the BGP process 30 and the LLDP process 32, and sharing a link with another router (not shown), which may operate in the same manner as the router 20. An LLDP instance of the other (remote) router (not shown) advertises its MAC address (“remote MAC address”) on the link to the router 20, such that the LLDP process 32 receives the remote MAC address of the other router. The LLDP process 32 then provides the remote MAC address to the BGP process 30. The BGP process 30 may then automatically compute the IPv6 link local address and the autonomous system (AS) number of the other router from the remote MAC address. The BGP process 30 may store the IPv6 link-local address, the AS number, and the address family of the first router in an internal data structure, such as in a Specific BGP Neighbor Configuration table (see FIG. 5), to configure the BGP peer neighborship for a BGP neighbor having an IPv4 address family.

It should be recognized that each router in the network will both advertise a local MAC address to another router and receive an advertisement of a local MAC address from the other router. Accordingly, the router 20 is shown sending its own outgoing LLDP advertisement (see dashed lines) that includes the MAC address (“local MAC address”) of the router 20. The other router sharing the link will receive the LLDP advertisement and may process it in the same manner as described here for the router 20, such that the other router may determine and store the IPv6 link local address and the autonomous system (AS) number of the router 20 for subsequent communication with the router 20.

FIG. 3B is a diagram of the router 20 running the BGP process 30 and the LLDP process 32, and sharing a link with another router (not shown), which may operate in the same manner as the router 20. FIG. 3B illustrates an embodiment in which the LLDP process of the other (remote) router (not shown) advertises its IPv6 link local address (“remoted IPv6 link-local address”) and its autonomous system (AS) number (“remote AS number”) on the link to the router 20. The LLDP process 32 then provides the remote IPv6 link-local address and AS number to the BGP process 30. Accordingly, the BGP process 30 is provided with the remote IPv6 link local address and the remote autonomous system (AS) number of the other router, such that this information does not need to be calculated. The BGP process 30 may then store the remote IPv6 link-local address, the remote AS number, and the address family of the other router in an internal data structure, such as in a Specific BGP Neighbor Configuration table (see FIG. 5), to configure the BGP peer neighborship for a BGP neighbor having an IPv4 address family.

It should be recognized that each router in the network will both send and receive an LLDP advertisement. Accordingly, the BGP process 30 is shown provide the AS number for the router 20 to the LLDP process 32 (see dashed lines) and the LLDP process 32 is shown subsequently sending an outgoing LLDP advertisement (see dashed lines) that includes the local AS number of the router 20 and the local IPv6 link-local address of the router 20. The other router sharing the link will receive the LLDP advertisement and may process it in the same manner as described here for the router 20, such that the other router may receive and store the IPv6 link local address and the autonomous system (AS) number of the router 20 for subsequent communication with the router 20.

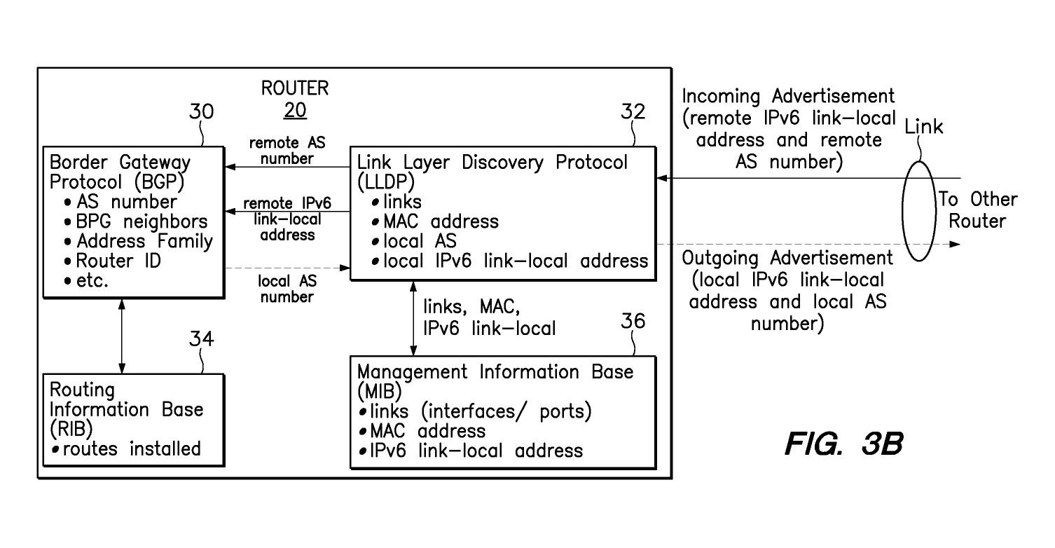

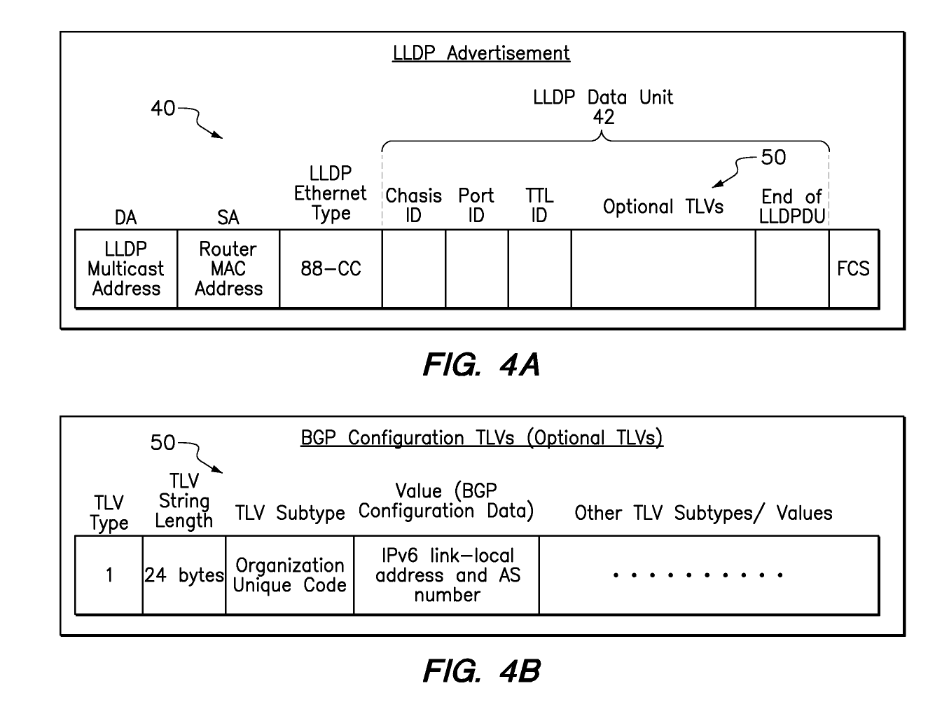

FIG. 4A is a diagram of an Ethernet frame 40 forming an LLDP Advertisement including an LLDP Data Unit 42 that provides for optional Type-Length-Value (TLV) fields. Such an Ethernet frame 40 may be sent over a link from one (sending) router to another (receiving) router. In one option, the sending router provides the receiving router with a MAC address for the port (interface) that forms one end of the link. For example, the LLDP Advertisement may include a source address (SA) that identifies the MAC address for the router. Upon receipt of the Ethernet frame 40, the receiving router may calculate an IPv6 link-local address and autonomous system (AS) number for the sending port (interface) and transmit subsequent communications to the router that sent the LLDP Advertisement using the calculate IPv6 link-local address and autonomous system (AS) number. In a separate option, the sending router may include its own IPv6 link-local address and autonomous system (AS) number in the LLDP Advertisement, such that the receiving router merely reads and stores this information for use in transmitting subsequent communication to the sending router. For example, the IPv6 link-local address and autonomous system (AS) number may be included in one or more optional TLV field that is part of the LLDP Advertisement.

FIG. 4B is a diagram of an optional TLV field 50 of the LLDP Advertisement of FIG. 4A. As shown, the optional TLV field 50 may contain BGP Configuration TLV fields for conveying BGP configuration information between routers. In this optional TLV field, the IPv6 link-local address and AS number are provided to the receiving router and do not require calculation by the receiving router. For example, the TLV Type may indicate an organization specific field (TLV Type 1), a TLV String Length of 24 bytes, and an organization unique code (i.e., indicating a LENOVO proprietary TLV Subtype). Then, the Value field may include BGP configuration data, such as the IPv6 link-local address and the AS number. For example, the Value field may include “0000000efe80000000000000562aa2fffed4da02”, in which “0000000e” indicates the AS number of 14 (the decimal value of hexadecimal “0000000e”) and “fe80000000000000562aa2fffed4da02” provides the IPv6 link-local address.

FIG. 5 is a diagram of BGP Internal Information that is maintained by an instance of the BGP process running on a router, such as the BFP process shown in FIG. 3. The diagram includes separate data structures for Global BGP Configuration data and Specific BGP Neighbor Configuration data. While the data structures are illustrated as tables, it should be recognized that other data structures may be used to maintain the same data.

For any given router, the BGP neighborship configuration involves certain information for the Global BGP configuration, the Specific BGP Neighbor Configuration, and the individual interface IP configuration. As shown, the Global BGP configuration for the router includes a field for an Autonomous System (AS) number, a Router identifier (ID), an Address Family (IPv4 or IPv6), whether Equal Cost Multipath (ECMP) is disabled or enabled by a max number of equal paths supported, and whether Multipath Relax is enabled or disabled. The Specific BGP Neighbor Configuration includes a record for each BGP neighbor router in order identify the IPv6 link-local address and the AS number for that BGP neighbor router. While the Global BGP configuration (i.e., the autonomous system number, router ID, and enabling automatic configuration using IPv6 link-local addresses) is manually setup for each router, the specific neighbor configuration and individual interface IPv6 link-local address and AS number configuration is performed automatically on each port.

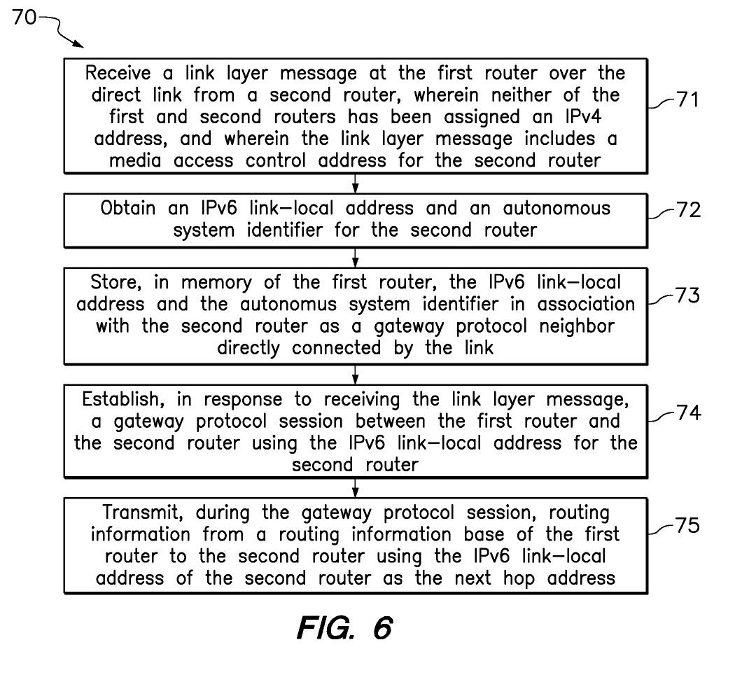

FIG. 6 is a flow diagram of a method 70 for a first router to automatically share network routing information with a second router over a direct link between the first router and the second router. In step 71, a first router receives a link layer message at a first port of the first router over the direct link from a second router, wherein neither of the first and second routers has been assigned an IPv4 address, and wherein the link layer message includes a media access control address for the second router. In step 72, the first router obtains an IPv6 link-local address and an autonomous system identifier for the second router. In step 73, the first router stores, in memory of the first router, the IPv6 link-local address and the autonomous system identifier in association with the second router as a gateway protocol neighbor directly connected by the link. In step 74, the first router establishes, in response to receiving the link layer message, a gateway protocol session between the first router and the second router using the IPv6 link-local address for the second router. In step 75, the first router transmits, during the gateway protocol session, routing information from a routing information base of the first router to the second router using the IPv6 link-local address of second router as the next hop address.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising non-transitory computer readable storage media having program instructions embodied therewith for a first router to automatically share network routing information with a second router over a direct link between the first router and the second router, the program instructions executable by a processor to:
receive a link layer message at the first router over the direct link from a second router, wherein neither of the first and second routers has been assigned an IPv4 address, and wherein the link layer message includes a media access control address for the second router;
obtain an IPv6 link-local address and an autonomous system identifier for the second router;
store, in memory of the first router, the IPv6 link-local address and the autonomous system identifier in association with the second router as a gateway protocol neighbor directly connected by the link;
establish, in response to receiving the link layer message, a gateway protocol session between the first router and the second router using the IPv6 link-local address for the second router; and
transmit, during the gateway protocol session, routing information from a routing information base of the first router to the second router using the IPv6 link-local next hop address of second router.

2. The computer program product of claim 1, wherein the routing information includes one or more routes including an IPv4 destination address and an IPv6 link-local next hop address, and wherein the program instructions are further executable by the processor to:
route IPv4 packets from the first router to the second router using the IPv6 link-local next hop address.

3. The computer program product of claim 1, wherein the program instructions executable by the processor to obtain the IPv6 link-local address and the autonomous system identifier for the second router include program instructions executable by the processor to calculate the IPv6 link-local address and the autonomous system identifier using the media access control address received from the second router in the link layer message.

4. The computer program product of claim 1, wherein the link layer message is a Link Layer Discovery Protocol message, and wherein the gateway protocol is Border Gateway Protocol.

5. The computer program product of claim 1, wherein the program instructions executable by the processor to obtain the IPv6 link-local address and the autonomous system identifier for the second router include program instructions executable by the processor to read the IPv6 link-local address and the autonomous system identifier for the second router in the link layer message received at the first router over the link from the second router, and wherein the link layer message includes a type-length-value packet including the IPv6 link-local address and the autonomous system identifier of the second router.

6. The computer program product of claim 1, wherein the first and second routers are in the same network.

7. The computer program product of claim 6, wherein the first router is selected from the group consisting of a line card and a fabric card.

8. The computer program product of claim 7, wherein the network is a multistage network including a plurality of line cards, a plurality of fabric cards, and a plurality of servers, wherein each server has a direct link to a line card, each line card has a direct link to each fabric card, there is no direct link between any two of the line cards, and there is no direct link between any two of the fabric cards.

9. The computer program product of claim 1, wherein the program instructions are further executable by the processor to:
store, in the memory of the first router, global gateway protocol information for the second router, wherein the global gateway protocol information includes an autonomous system number, router identifier, address family, an equal cost multipath setting, and a multipath relax setting.

10. The computer program product of claim 1, wherein the program instructions are further executable by the processor to:
store, in the memory of the first router, specific gateway protocol information for the second router, wherein the specific gateway protocol information for the second router includes an autonomous system number, an address family of the second router and the IPv6 link-local address.

11. The computer program product of claim 1, wherein the program instructions are further executable by the processor to:
determine an autonomous system number for the second router as a function of the media access control address of the second router; and
store, in the memory of the first router, the autonomous system number in association with the IPv6 link-local address for the second router.

12. The computer program product of claim 1, wherein the routing information includes a plurality of route records, each route record identifying a destination address and a next hop address, wherein one or more route record has an IPv4 address for the destination address and an IPv6 link-local address for the next hop address.

13. A router, comprising:
at least one non-transitory data storage device for storing program instructions; and
at least one processor for processing the program instructions to:
receive a link layer message over a direct link from a second router, wherein neither of the first and second routers has been assigned an IPv4 address, and wherein the link layer message includes a media access control address for the second router;
obtain an IPv6 link-local address and an autonomous system identifier for the second router;
store, in memory of the first router, the IPv6 link-local address and the autonomous system identifier in association with the second router as a gateway protocol neighbor directly connected by the link;
establish, in response to receiving the link layer message, a gateway protocol session between the first router and the second router using the IPv6 link-local address for the second router; and
transmit, during the gateway protocol session, routing information from a routing information base of the first router to the second router using the IPv6 link-local next hop address of second router.

14. The router of claim 13, wherein the routing information includes one or more routes that include an IPv4 destination address and an IPv6 link-local next hop address, the at least one processor for further processing the program instructions to:
route IPv4 packets from the first router to the second router using the IPv6 link-local next hop address.

15. The router of claim 13, wherein the program instructions to obtain the IPv6 link-local address and the autonomous system identifier for the second router include program instructions to calculate the IPv6 link-local address and the autonomous system identifier as a function of the media access control address received from the second router.

16. The router of claim 13, wherein the IPv6 link-local address and the autonomous system identifier for the second router are obtained in the link layer message received at the first router over the link from the second router, and wherein the link layer message includes a type-length-value packet including the IPv6 link-local address and the autonomous system identifier of the second router.

17. A method for a first router to automatically share network routing information with a second router over a direct link between the first router and the second router, comprising:
receiving a link layer message at a first port of the first router over the direct link from the second router, wherein neither of the first and second routers has been assigned an IPv4 address, and wherein the link layer message includes a media access control address for the second router;
obtaining an IPv6 link-local address and an autonomous system identifier for the second router;
storing, in memory of the first router, the IPv6 link-local address and the autonomous system identifier in association with the second router as a gateway protocol neighbor directly connected by the link;
establishing, in response to receiving the link layer message, a gateway protocol session between the first router and the second router using the IPv6 link-local address for the link with the second router; and
transmitting, during the gateway protocol session, routing information from a routing information base of the first router to the second router using the IPv6 link-local address of second router as the next hop address.

18. The method of claim 17, wherein the routing information including one or more routes including an IPv4 destination address and an IPv6 link-local next hop address, the method further comprising:
routing IPv4 packets from the first router to the second router using the IPv6 link-local next hop address.

19. The method of claim 17, wherein the IPv6 link-local address for the second router is obtained by calculating the IPv6 link-local address as a function of the media access control address received from the second router.

20. The method of claim 17, wherein the IPv6 link-local address and the autonomous system identifier for the second router are obtained in the link layer message received at the first router over the link from the second router, and wherein the link layer message includes a type-length-value packet including the IPv6 link-local address and the autonomous system identifier of the second router.
